(19) United States
(12) Patent Application Publication
(10) Pub. No.: US 2023/0259472 A1
(43) Pub. Date: Aug. 17, 2023

(54) CENTRALIZED MANAGEMENT OF PERIPHERAL DEVICES

(71) Applicant: Hewlett-Packard Development Company, L.P., Spring, TX (US)

(72) Inventors: Syed S. Azam, Spring, TX (US); Louis R. Jackson, Jr., Spring, TX (US); Gregory Staten, Spring, TX (US)

(73) Assignee: Hewlett-Packard Development Company, L.P., Spring, TX (US)

(21) Appl. No.: 18/005,293

(22) PCT Filed: Jul. 17, 2020
(86) PCT No.: PCT/US2020/042471

§ 371 Date: Jan. 12, 2023

(51) Int. Cl. G06F 13/362

(52) U.S. Cl. CPC G06F 13/362

(57) ABSTRACT

A peripheral management device is communicatively connected over a network with a client device and with host devices having peripheral devices. The peripheral management device provides for centralized management of the peripheral devices of the host devices by the client devices through the peripheral management device and the host devices.

### BACKGROUND

Enterprises and other organizations can have computing devices numbering in the hundreds, thousands, or even more. Such computing devices include desktop computers, portable computers like laptop and notebook computers, as well as other types of computing devices. Employees and other users may each have their own computing device or devices, and/or multiple users may share computing devices. Computing devices often have peripheral devices connected to them, particularly display devices in the case of desktop computers.

### BRIEF DESCRIPTION

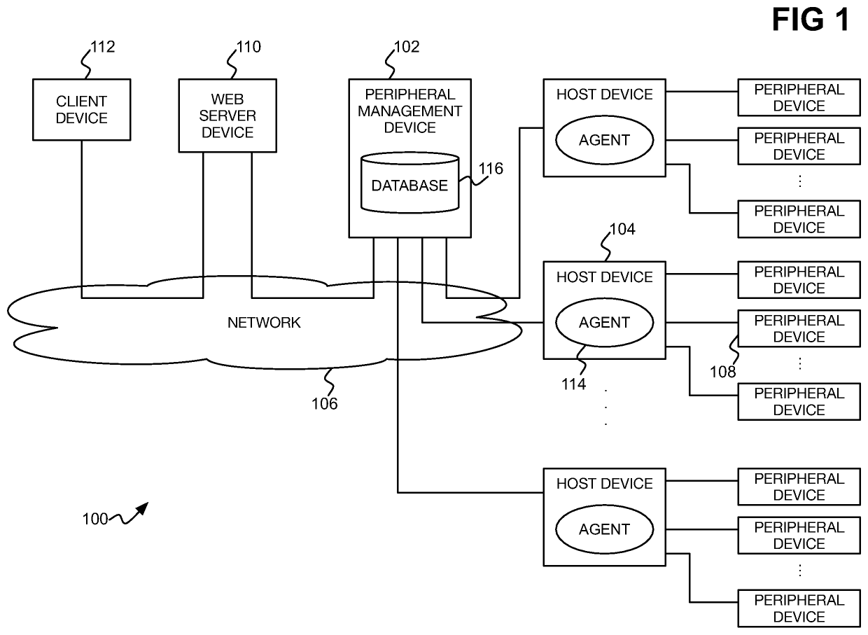

FIG. 1 is a diagram of an example system in which a peripheral management device provides for central management of peripheral devices of host devices.

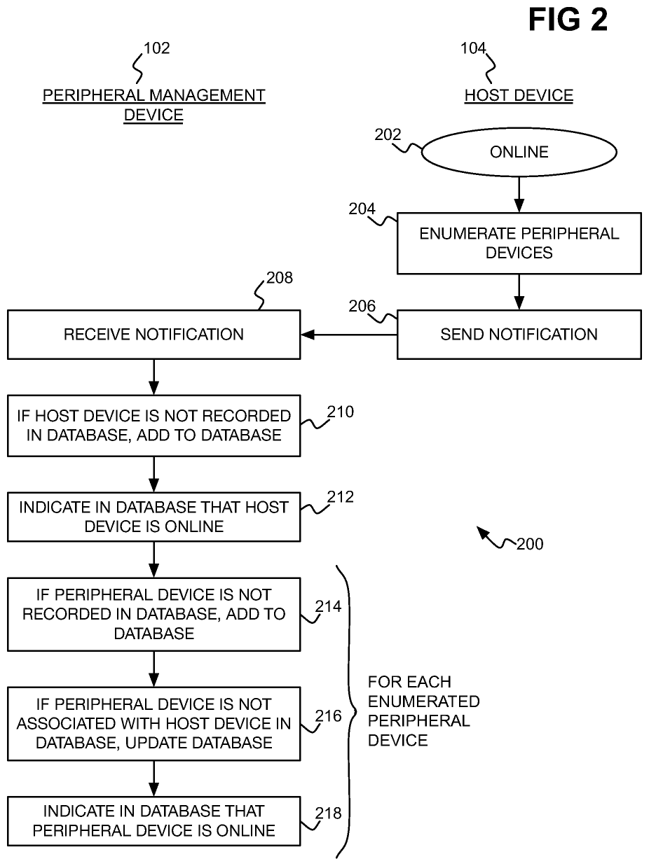

FIG. 2 is a flowchart of an example method that is performed when a host device having peripheral devices comes online.

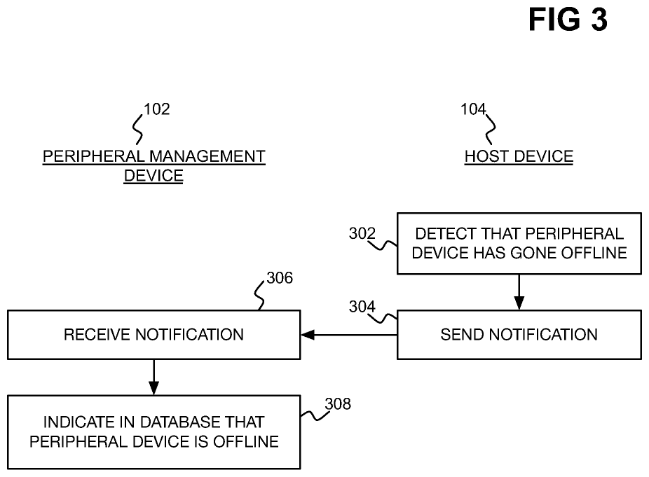

FIG. 3 is a flowchart of an example method that is performed when a peripheral device of an online host device goes offline.

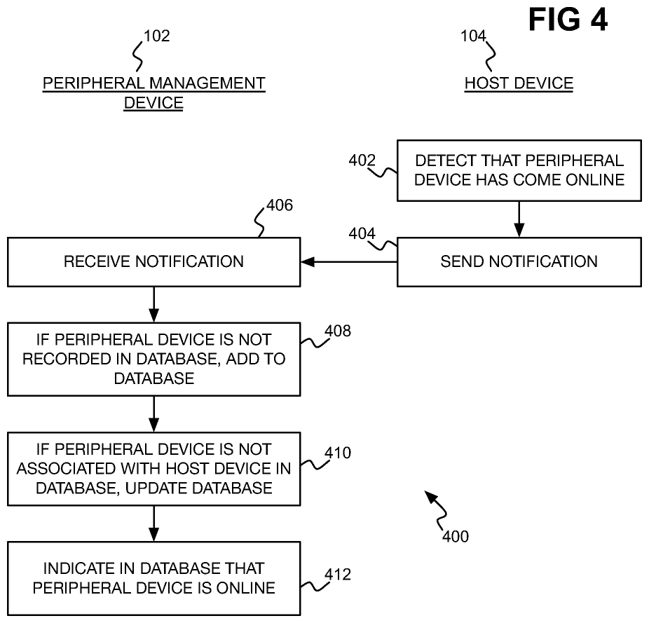

FIG. 4 is a flowchart of an example method that is performed when a new or previously offline peripheral device comes online at an online peripheral device.

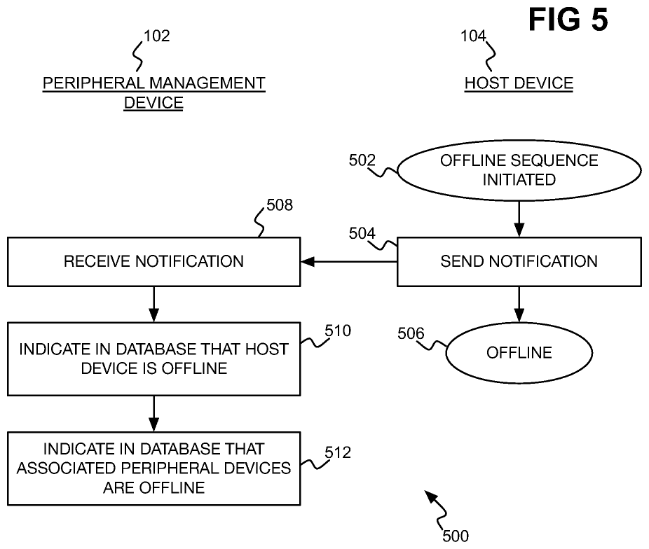

FIG. 5 is a flowchart of an example method that is performed when a host device having peripheral devices goes offline in a controlled manner.

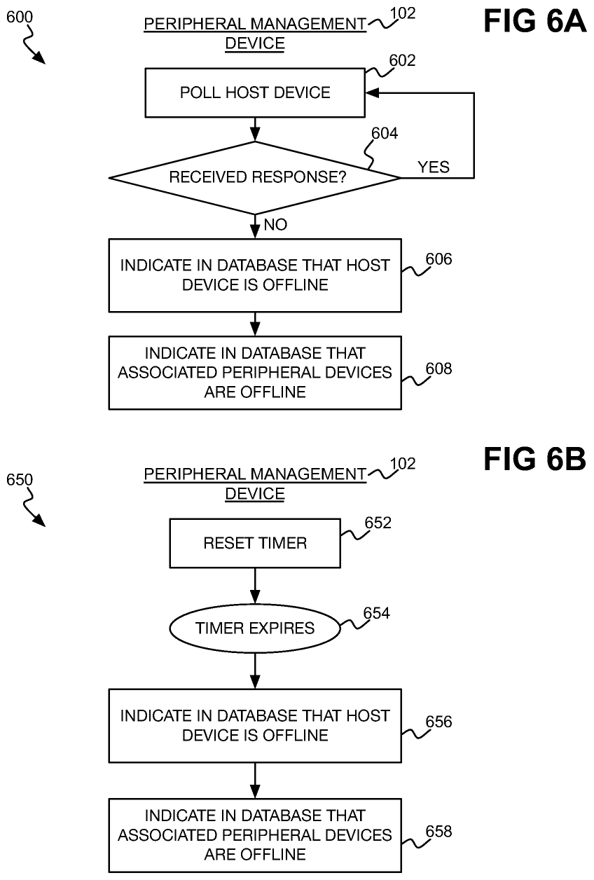

FIGS. 6A and 6B are flowcharts of different example methods that are performed when a host device having peripheral devices goes offline in a controlled or uncontrolled manner.

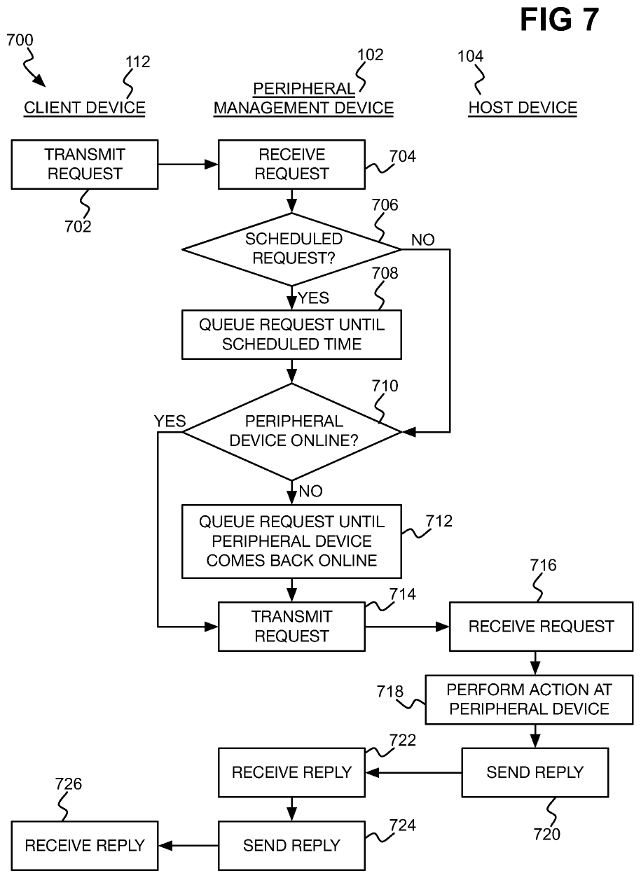

FIG. 7 is a flowchart of an example method that is performed for performing a management action at a peripheral device via its connected host device and through a peripheral management device.

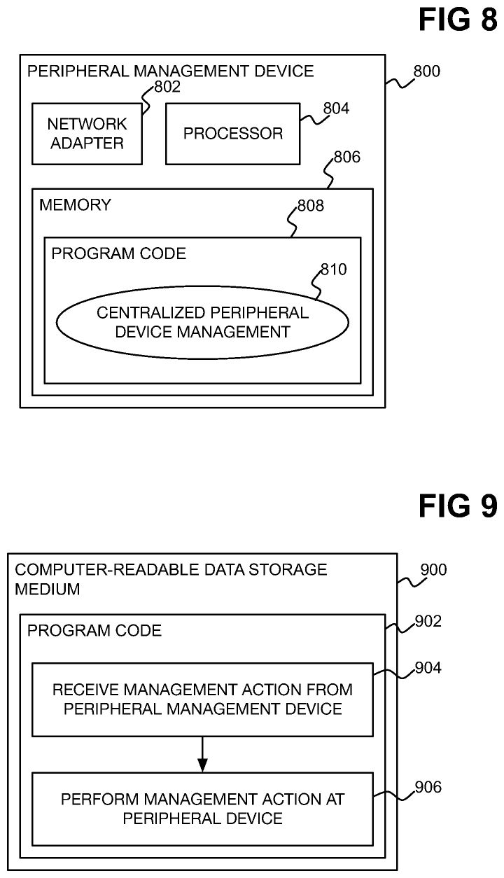

FIG. 8 is a diagram of an example peripheral management device.

FIG. 9 is a diagram of an example computer-readable data storage medium.

### DETAILED DESCRIPTION

As noted in the background, enterprises and other organizations can have large numbers of computing devices, including desktop, laptop, and notebook computers, for usage by their employees and other users. The computing devices may themselves have peripheral devices like display devices, cameras (e.g., webcams), docks, hubs, scanners, printers, and so on. Peripheral devices may not always be connected to their computing devices, and peripheral devices may be connected to different computing devices at different times. For example, a display device like a monitor may be moved from one desktop computer to another desktop computer.

To maintain their computing devices, organizations like enterprises may rely upon management software. Such management software permits administrators or other users to manage large numbers of computing devices over a network without having to physically handle every device in person. However, peripheral devices generally cannot be managed using management software. This means that the peripheral devices cannot have their firmware and other software managed, nor their configuration settings or parameters changed, using the management software by which the computing devices to which the peripheral devices are connected are managed.

Some types of peripheral devices, such as printing devices like standalone printers and all-in-one (AIO) devices that combine printing functionality with other types of functionality like scanning, as well as a limited number of display devices, not uncommonly have their own network connectivity and can be separately connected to a network apart from their being connected to computing devices that are connected to the network. These types of peripheral devices may be able to be centrally managed. For instance, such peripheral devices may be managed via management software apart from the management software used to manage the computing devices that connect to the peripheral devices.

However, to great extent most display devices and other peripheral devices lack network connectivity and are connected to just their host computing devices. These peripheral devices generally cannot be managed using centralized management software. An administrator or other user may thus have to update the firmware and settings of the peripheral devices by individually visiting each device in person. The user may instead rely on remote desktop software to remotely control or use each host computing device to which peripheral devices are connected to manage the peripheral devices, on a per-host computing device basis, which is laborious at best.

Techniques described herein provide for centralized management of peripheral devices of host computing devices, which are referred to as host devices herein. The peripheral devices do not have to have network connectivity and thus do not have to be separately connected to a network apart from their being connected to host devices that are, in order for the peripheral devices to be managed. The peripheral devices are instead centrally managed through a peripheral management device in communication with the host devices to which the peripheral devices are connected, without having to individually establish a remote desktop control session with each host device.

FIG. 1 shows an example system 100 in which centralized peripheral device management occurs. The system 100 includes a peripheral management device 102 and host devices 104, one of which is particularly referenced in FIG. 1. The peripheral management device 102 may be a server computing device, or server. The host devices 104 may be computing devices like desktop, laptop, and notebook computers. The peripheral management device 102 and the host devices 104 are communicatively connected to one another over a network 106, which can be or include the Internet, intranets, extranets, local-area networks (LANs), wide-area networks (WANs), and so on.

Each host device 104 can have one or multiple peripheral devices 108 connected thereto, one of which is particularly referenced in FIG. 1. The peripheral devices 108 may be display devices like monitors, docks, hubs, cameras like webcams, printers, scanners, and other types of peripheral devices. Each peripheral device 108 is connected to a host device 104 in a non-networked manner, such as via universal serial bus (USB), Thunderbolt, high-definition multimedia interface (HDMI), Bluetooth, and so on. That is, the peripheral devices 108 are not connected to the host device 104 over the network 106 or a different network.

The system 100 can include a web server device 110 that is communicatively connected to the peripheral management device 102. In the example of FIG. 1, the web service device 106 and the peripheral management device 102 are communicatively connected over the same network 106 over which the host devices 104 are communicatively connected to the peripheral management device 102. However, in another implementation, the web service device 106 and the peripheral management device 102 may be communicatively connected over a different network.

The system 100 can include a client device 112 that is communicatively connected to the web server device 110, such as over the network 106 as in FIG. 1. The client device 112 may instead be communicatively connected to the web server device 110 over a different network, which may be the same network over which the web server device 110 is communicatively connected with the peripheral management device 102. As a third example, the client device 112 may be communicatively connected device over a network that is different than the network 106 and different than the network over which the web server device 110 is communicatively connected with the peripheral management device 102.

The peripheral management device 102 may be located at the same premises as the host devices 104, or at a different location. The peripheral management device 102 may be implemented as a discrete device or by using cloud computing techniques. The web server device 110 may similarly be located on the same premises as the peripheral management device 102, or at a different location. The web server device 110 may likewise be implemented as a discrete device or by using cloud computing techniques. In the example of FIG. 1, the client device 112 communicates with the peripheral management device 102 through the web server device 110, but in another implementation may directly communicate with the peripheral management device 102.

In general, the peripheral management device 102 permits and provides for centralized management of the peripheral devices 108 of the host devices 104. For example, an administrator or other user may use the client device 112 to interact with the peripheral management device 102 through the web server device 110. The client device 112 may be a desktop, laptop, or notebook computer, for instance, or a mobile computing device like a smartphone or tablet computing device. One such client device 112 is depicted in FIG. 1, but more generally there can be multiple client devices. The client device 112 may run a web browser, for instance, which accesses a web site exposed by the web server device 110 to utilize the centralized peripheral management functionality of the peripheral management device 102.

The host devices 104 act as a proxy between the peripheral management device 102 and the peripheral devices 108, permitting the peripheral management devices 102 to centrally manage the peripheral devices 108 at behest of the user of the client device 112 through the host devices 104. In this respect, the host devices 104 may run software agents 114, one of which is particularly identified in FIG. 1, and which permit management actions to be performed at the peripheral devices 108 under direction of the peripheral management device 102. The software agents 114 communicate with the peripheral devices 108 over the direct connections between the peripheral devices 108 and the host devices 104 and communicate with the peripheral management device 102 over the network 106.

For example, a peripheral device 108 may be a display device. The host device 104 to which the peripheral device 108 is connected may be able to perform management actions at the peripheral device 108 over a display data channel (DDC) provided at the HDMI or other connection over which the host device 104 also transmits information to be displayed on the peripheral device 108. As another example, also in the case in which the peripheral device 108 is a display device, the host device 104 may communicate with the peripheral device 108 over a separate connection, such as a USB connection, different than the HDMI or other connection over which the host device 104 transmits information to be displayed on the peripheral device 108.

The software agent 114 of the host device 104 can be a computer program that runs on the host device 104 and that interacts with the peripheral management device 102 on behalf of the peripheral device 108. The software agent 114 may be installed as an operating system service in one implementation, for instance. The software agent 114 may in another implementation be installed as a standalone computer program running on the operating system of the host device 104.

The software agent 114 of the host device 104 can perform different types of management actions at the peripheral device 108. For example, the agent 114 may update the software that the peripheral device 108 runs, such as firmware. The agent 114 may update the configuration settings of the peripheral device 108. In the case of a display device, such settings can include power conservation settings, including whether and when the display device should enter a power saving mode, as well as an instruction to immediately enter the power saving mode. The power saving mode may entail turning off the display of the display device or causing the display device to enter a sleep mode.

Other configuration settings in the case of a display device include display parameters, such as brightness, contrast, color profile, and so on. The management actions can include retrieving the current configuration settings and the current versions of the software (e.g., firmware) of the peripheral device 108 as well as changing them. Similarly, the management actions can include retrieving static information regarding the peripheral device 108. Such static information can include the type, make, and model of the peripheral device 108, the capabilities of the peripheral device 108, and so on.

The software agent 114 of the peripheral management device 102 may in turn communicate with the peripheral management device 102 over an Internet-based or other networking protocol. For example, the software agent 114 may communicate with the peripheral management device 102 using a WebSocket, which is a type of communications protocol that provides for full-duplex communication channels over a transmission control protocol (TCP) connection. The peripheral management device 102 may similarly communicate with the web server device 110 using a WebSocket or via a different protocol. The client device 112 may also communicate with the web server device 110 using a WebSocket, or via a different protocol such as the hypertext transport protocol (HTTP) in the case in which the web server device 110 exposes a web site for the peripheral management device 102.

The peripheral management device 102 maintains a database 116 of the host devices 104, the peripheral devices 108, and information regarding the devices 104 and 108, including whether each is currently online or offline. A host device 104 is online if it is powered on and currently communicatively connected to the peripheral management device 102 and is offline if powered off or is powered on but not currently communicatively connected to the peripheral management device 102. For instance, the host device 104 may be powered on but unable to connect to the network 106, rendering it communicatively disconnected from the peripheral management device 102.

A peripheral device 108 is online if it is powered on (even if in a power saving mode) and currently connected to a host device 104. A peripheral device 108 is offline if it is powered off or powered on but not connected to a host device 104. A peripheral device 108 may be online at one host device 104 and then go offline and come online at a different host device 104 if, for instance, it is disconnected from the former host device 104 and moved and connected to the latter host device 104.

The database 116 that the peripheral management device 102 maintains also stores other information regarding the host devices 104 and the peripheral devices 108. For example, the database 116 may store identifying information of each host device 104, such as the user account logged into (i.e., the user associated with) the host device 104, the location of the host device 104, and so on. The location of the host device 104 thus is the location of each peripheral device 108 connected to the host device 104. As another example, the database 116 may store the configuration settings of each peripheral device 108, the aforementioned static information of each peripheral device 108, and so on.

The peripheral devices 108 can therefore be logically organized over different groups of different group types, with the peripheral management device 102 providing for centralized management of the peripheral devices 108 at a group level of one group or multiple groups of the same or different types. For example, an administrator using the client device 112 may request that the display devices on certain floors of an office and that are connected to host devices 104 of clerical employees have their displays turned off, immediately or in a scheduled recurring or non-recurring manner. As another example, an administrator may request that the display devices located in westward-facing portions of a building have their brightness decreased in correspondence with the setting of the sun, or that the display devices in window-facing locations have their brightness modified based on current local weather conditions (e.g., sunny or cloudy).

The peripheral management device 102 may thus expose, via the web server device 110 in one implementation, a dashboard conveying the status of the peripheral devices 108. Using the client device 112, an administrator may group the peripheral devices 108 in different ways and inspect the current information regarding the devices 108. The administrator may cause management actions to be immediately performed or scheduled for later performance at individual peripheral devices 108, as well as at groups of peripheral devices 108. As the management actions are performed, their completion status may be indicated implicitly or explicitly on the dashboard, in the form of when the actions were performed, whether they were successfully performed, and so on. For instance, if the management action is to change the color profile of a display device, the completion status of the action may be implicitly indicated insofar as the current color profile of the display device is shown on the dashboard.

In providing for centralized management of the peripheral devices 108, the peripheral management device 102 does not communicate directly with any peripheral device 108. Rather, the peripheral management device 102 communicates directly with the host devices 104 to which the peripheral devices 108 are connected. The host devices 104, via their software agents 114, thus actually perform the management actions at the peripheral devices 108, under direction of the peripheral management device 102. As noted, the host devices 104 serve as a proxy between the peripheral management device 102 and the peripheral devices 108 in this respect.

Furthermore, in performing centralized management of the peripheral devices 108, an administrator or other user does not establish remote desktop control sessions with the host devices 104 via the client device 112. That is, the centralized management that the peripheral management device 102 provides is not remote desktop control functionality. Whereas remote desktop control functionality permits a user to control an individual host device 104 via the client device 112 as if the user were physically present at the host device 104, the user does not have to and does not control the host device 104 in such a manner when managing the peripheral devices 108 via the peripheral management device 102. Further, the user can cause simultaneous or concurrent performance of management actions at peripheral devices 108 connected to multiple host devices 104 via the centralized management that the peripheral management device 102 provides, which is not possible with remote desktop control techniques.

FIGS. 2-5, 6A, and 6B, show example methods by which the peripheral management device 102 accurately maintains the database 116 of the host devices 104 and the peripheral devices 108. FIG. 2 specifically shows an example method 200 that is performed when a host device 104 having peripheral devices 108 comes online for the first time or after having been offline. For example, the method 200 may be performed when the host device 104 is powered on and is communicatively connected to the network 106, or when the communicative connection to the network 106 resumes after having been interrupted for sufficiently long to cause the host device 104 to go offline.

The method 200 is described in relation to one host device 104 (e.g., a selected host device 104), but is applicable to each host device 104. The peripheral management device 102 performs the left parts of the method 200, whereas the host device 104 performs the right parts of the method 200. The method 200 may be implemented as program code stored on a non-transitory computer-readable data storage medium and executable by a processor, such as that of the device 102 or 104. The program code in the case of the host device 104 may be or realize the software agent 114 of the device 104.

When the host device 104 comes online after having been offline (202), the host device 104 may enumerate the peripheral devices 108 connected to the host device 104 and that are also online (204). The host device 104 sends a corresponding notification to the peripheral management device 102 (206), which receives the notification (208). The notification can include an identifier and other information regarding the host device 104, as well as the identifier and other information regarding each online peripheral device 108 that the host device 104 enumerated.

If the host device 104 is not recorded in the database 116, the peripheral management device 102 adds it to the database 116 (210). That is, the peripheral management device 102 records the host device 104 in the database 116 if the host device 104 is a new host device 104 that was not previously tracked in the database 116. The peripheral management device 102 may add a record for the host device 104, for instance, which includes the identifier and other information regarding the host device 104. This information may include location information of the host device 104, the user currently logged into (i.e., associated with) the host device 104, and so on.

The peripheral management device 102 indicates in the database 116 that the host device 104 is online (212). For instance, the peripheral management device 102 may update a record for the host device 104 in the database 116 to indicate that the host device 104 is online. This record may be the record just created in part 210, or the record previously created for the host device 104 in a prior performance of the method 200 as to the host device 104 in question.

The peripheral management device 102 performs the following for each peripheral device enumerated in part 204. If the peripheral device 108 is not recorded in the database 116, the peripheral management device 102 adds it to the database 116 (214). That is, the peripheral management device 102 records the peripheral device 108 in the database 116 if the peripheral device 108 is a new peripheral device 108 that was not previously tracked in the database 116. The peripheral management device 102 may add a record for the peripheral device 108, for instance, which includes the identifier and other information regarding the host device 104. This information may include the type, model, make, and capabilities of the peripheral device 108, and so on.

If the peripheral device 108 is not associated with the host device 104 in the database 116, the peripheral management device 102 accordingly updates the database 116 (216). That is, the peripheral management device 102 associates the peripheral device 108 with the host device 104 in the database 116. For example, if the peripheral device 108 is a new peripheral device 108, then it will not have been associated with any host device 104 in the database 116. As another example, the peripheral device 108 may be currently associated with a different host device 104 in the database 116, but may have been disconnected from this host device 104 and connected to a new host device 104.

The peripheral management device 102 may associate the peripheral device 108 with the host device 104 in the database 116 in a number of different ways. There may be a linking field of the record for the host device 104 that can be updated or created to reference the record for the peripheral device 108. (The linking field of the prior host device 104 with which the peripheral device 108 had been associated, if any, may correspondingly be updated or deleted to no longer reference the record for the peripheral device.) There may similarly be a linking field of the record for the peripheral device 108 that can be updated or created to reference the record for the host device 104. Either or both of these linking fields may be present. There may additionally or instead be a separate linking record that is updated or created that links the record for the host device 104 to the record for the peripheral device 108.

The peripheral management device 102 indicates in the database 116 that the peripheral device 108 is online (218). For instance, the peripheral management device 102 may update a record for the peripheral device 108 in the database 116 to indicate that the peripheral device 108 is online. This record may be the record just created in part 214, or the record previously created for the peripheral device 108 in a prior performance of the method 200 (or the method 400 of FIG. 4, as will be described) as to the peripheral device 108 in question.

FIG. 3 specifically shows an example method 300 that is performed when a currently online peripheral device 108 of an online host device 104 goes offline while the host device 104 remains online. For example, the method 300 may be performed when a currently online peripheral device 108 is disconnected from a host device 104 that is also currently online. The method 300 is thus performed after the method 200 of FIG. 2 has been performed.

The method 300 is described in relation to one peripheral device 108 of one host device 104 (e.g., a selected peripheral device 108 of a selected host device 104), but is applicable to each online peripheral device 108 of each online host device 104. The peripheral management device 102 performs the left parts of the method 300, whereas the host device 104 performs the right parts of the method 300. The method 300 may be implemented as program code stored on a non-transitory computer-readable data storage medium and executable by a processor, such as that of the device 102 or 104. The program code in the case of the host device 104 may be or realize the software agent 114 of the device 104.

The host device 104 detects that the peripheral device 108 has gone offline (302). For instance, the peripheral device 108 may have been disconnected and/or powered off, such that the host device 104 is no longer able to communicate with the peripheral device 108. The host device 104 accordingly sends a notification to the peripheral management device 102 (304), which receives the notification (306). The notification can include an identifier of the peripheral device 108 and may also include an identifier of the host device 104.

The peripheral management device 102 responsively indicates in the database 116 that the peripheral device 108 is now offline (308). For instance, the peripheral management device 102 may update a record for the peripheral device 108 to indicate that the device 108 is now offline. The association of the peripheral device 108 with the host device 104 may remain in the database 116, however. This permits an administrator or other user to identify the host device 104 with which the peripheral device 108 was associated the last time the peripheral device 108 was online, which may be useful should, for example, the peripheral device 108 go missing.

FIG. 4 specifically shows an example method 400 that is performed when a new or previously offline peripheral device 108 comes online at an online host device 104. For example, the method 400 may be performed after a host device 104 has already been powered on and the method 200 of FIG. 2 performed. That is, the peripheral device 108 in relation to which the method 400 is performed is not one of the peripheral devices 108 enumerated in the method 200, but rather is a peripheral device 108 that comes online after the method 200 has been performed.

For example, a user may replace one display device for another display device at a host device 104 that is currently online. The method 300 of FIG. 3 is performed when the former display device goes offline. The method 400 is then performed when the latter display device comes online. The peripheral management device 102 performs the left parts of the method 400, whereas the host device 104 performs the right parts of the method 400. The method 400 may be implemented as program code stored on a non-transitory computer-readable data storage medium and executable by a processor, such as that of the device 102 or 104. The program code in the case of the host device 104 may be or realize the software agent 114 of the device 104.

The host device 104 detects that the peripheral device 108 has come online (402). For instance, the peripheral device 108 may have been powered on and/or connected to the host device 104, such that the host device 104 is newly able to communicate with the peripheral device 108. The host device 108 accordingly sends a notification to the peripheral management device 102 (404), which receives the notification (406). The notification can include an identifier of as well as other information regarding the peripheral device 108, and an identifier of the host device 104.

The peripheral management device 102 then performs processing akin to the processing that was performed in parts 214, 216, and 218 of FIG. 2 for each enumerated peripheral device 108. Specifically, if the newly online peripheral device 108 is not recorded in the database 116, the peripheral device 102 adds it to the database 116 (408), as in part 214. If the peripheral device 108 is not associated with the host device 104 in the database 116, the peripheral management device 102 accordingly updates the database 116 (410), as in part 216. The peripheral management device 102 indicates in the database 116 that the peripheral device 108 is online (412), as in part 218.

FIG. 5 specifically shows an example method 500 that is performed when a currently online host device 104 goes offline in a controlled or orderly manner. For example, a user of the host device 104 may initiate shutdown at the device 104 to power down the host device 104. As another example, the user may initiate entry of the host device 104 into a hibernation mode, which is a power savings mode in which the device 104 does not remain actively connected to the network 106 and thus goes offline. The method 500 is performed after the method 200 of FIG. 2 has been already performed.

The peripheral management device 102 performs the left parts of the method 500, whereas the host device 104 performs the right parts of the method 500. The method 500 may be implemented as program code stored on a non-transitory computer-readable data storage medium and executable by a processor, such as that of the device 102 or 104. The program code in the case of the host device 104 may be or realize the software agent 114 of the device 104.

When an offline sequence is initiated at the host device 104 in a controlled manner as noted above, the host device 104 sends a corresponding notification to the peripheral management device 102 (504), which receives the notification (508). The notification can include an identifier of the host device 104. Once the notification has been sent, the host device 104 may continue with the offline sequence, which culminates with the host device 104 going offline (506).

The peripheral management device 102 responsively indicates in the database 116 that the host device 104 is now offline (510). For instance, the peripheral management device 104 may update a record for the host device 104 to indicate that the device 104 is now offline. The peripheral management device 102 similarly indicates in the database 116 that the online peripheral devices 108 associated with the host device 104 are also now offline (512). For instance, the peripheral management device 104 may update a record for each such peripheral device 108 to indicate that it is now offline. The association of the peripheral device 108 with the host device 104 may remain in the database 116, however.

FIGS. 6A and 6B specifically show respective different example methods 600 and 650 that can be performed when a currently online host device 104 goes offline in a controlled or uncontrolled manner. If the method 500 of FIG. 5 is not performed when the host device 104 goes offline in a controlled manner, then the method 600 or 650 may be performed. That is, even when the method 500 is performed when the host device 104 goes offline in a controlled manner, the method 600 or 650 may be performed when the host device 104 goes offline in an uncontrolled manner.

For example, power may be removed from the host device 104 before orderly shutdown of the device 104 or orderly entry of the device 104 into hibernation mode has been initiated or completed, such as in error, due to a power outage, and so on. As another example, the host device 104 may lose network connectivity with the network 106 and thus no longer be communicatively connected to the peripheral manage device 102. The method 600 or 650 is performed once the method 200 of FIG. 2 has been performed.

The peripheral management device 102 performs both the methods 600 and 650. Either the method 600 may be performed in a polling implementation, or the method 650 may be performed in a heartbeat implementation. In another, combined polling-and-heartbeat implementation, both the methods 600 and 650 may be performed. In the method 600 of FIG. 6A, the peripheral management device 102 periodically polls the host device 104 to verify that it is still online (602). If the peripheral management device 102 receives a response from the host device 104 (604), then this means that the host device 104 is still online, and the peripheral management device 102 repeats the method 600 at part 602.

However, if the peripheral management device 102 does not receive a response from the host device 104 (604), then this means that the host device 104 is offline from the perspective of the peripheral management device 102. In one implementation, the peripheral management device 102 may not conclude that the host device 104 is offline until it has failed to receive responses to a threshold number of polling requests greater than one. The peripheral management device 102 then performs processing akin to the processing that is performed in parts 510 and 512 of FIG. 5 when the host device 104 goes offline in an orderly manner.

Specifically, the peripheral management device 102 indicates in the database 116 that the host device 104 is now offline (606), as in part 510. The peripheral management device 102 similarly indicates in the database 116 that the online peripheral devices 108 associated with the host device 104 are also now offline (608), as in part 512. The association of the peripheral devices 108 with the host device 104 may remain in the database 116, however.

In the method 650 of FIG. 6B, the peripheral management device 102 resets a timer when a notification is received from the host device 104 that the host device 104 is online (652). The timer is also reset when the method 200 of FIG. 2 is performed when the host device 104 first comes online. If the timer subsequently expires, then this means that the host device 104 is offline from the perspective of the peripheral management device 102. In one implementation, the peripheral management device 102 may not conclude that the host device 104 is offline until it has failed to receive such heartbeat notifications from the device 104 more than a threshold number of times greater than one within a threshold period of time.

As in parts 606 and 608 of FIG. 6A, the peripheral management device 102 then performs processing akin to the processing that is performed in parts 510 and 512 of FIG. 5 when the host device 104 goes offline in an orderly manner. The peripheral management device 102 indicates in the database 116 that the host device 104 is now offline (656) as in part 510 and similarly indicates in the database 116 that the online peripheral devices 108 associated with the host device 104 are also now offline (658) as in part 512. The association of the peripheral devices 108 with the host device 104 may remain in the database 116, however.

FIG. 7 shows an example method 700 for performing a management action at a peripheral device 108 via its connected host device 104 and through the peripheral management device 102. The method 700 is described in relation to one peripheral device 108 of one host device 104 (e.g., a selected peripheral device 108 of a selected host device 104). However, more generally, the method 700 can be performed in relation to more than one peripheral device 108 of one host device 104 or of more than one host device 104. As noted, the peripheral devices 108 can be grouped in different ways over different levels, and therefore a management action can be specified for performance at multiple peripheral devices 108 of the same or different host device 104 or host devices 104.

The client device 112 performs the left parts of the method 200, the peripheral management device 102 performs the middle parts of the method 200, and the host device 104 performs the right parts of the method 200. The method 200 may be implemented as program code stored on a non-transitory computer-readable data storage medium and executable by a processor, such as that of the device 112, 102, or 104. The program code in the case of the host device 104 may be or realize the software agent 114 of the device 104.

The client device 112 transmits a request for a management action to be performed at a peripheral device 108 (702). The request may specifically identify the peripheral device 108, such as by its identifier, or may identify the peripheral device 108 in another way. For instance, the request may identify the peripheral device 108 as a particular type of peripheral device 108, such as a display device, that is connected to a host device 104 that the request specifically identifies. As noted, the request may identify the peripheral device 108 by a group or multiple groups to which it belongs, such as the display devices on a particular floor of a building and/or that are currently associated with a specific type of user, and so on.

The peripheral management device 102 receives the request from the client device 112 (704). In the implementation in which the client device 112 and the peripheral management device 102 interact with one another through the web server device 110, the peripheral management device 102 receives the request from the web server device 110 over the network 106, which receives the request from the client device 112 over the network 106. In this case, the client device 112 transmits the request to the peripheral management device 102 via or through the web server device 110, and similarly the peripheral management device 102 receives the request from the client device 112 via or through the web server device 110. In another implementation, the client device 112 and the peripheral management device 102 may directly interact with one another over the network 106, without the web server device 110 intermediating.

The request may be for performing a management action now, or may be a request for performing the management action at a later time. The latter type of request is a scheduled request. The peripheral management device 102 thus determines if the request is a scheduled request (706) and if so queues or schedules performance of the management action at the time indicated in the request (708). The peripheral management device 102 in this case proceeds from part 708 of the method 700 once the scheduled time occurs. A scheduled request may further be a non-recurring or a recurring request. If the scheduled request is non-recurring, then the peripheral management device 102 proceeds from part 708 of the method 700 the next time the scheduled time occurs. If the scheduled request is recurring, then the peripheral management device 102 proceeds from part 708 of the method 700 every time the scheduled time occurs.

Once the scheduled time occurs in the case of a scheduled request, or immediately if the request is not a scheduled request, the peripheral management device 102 determines whether the peripheral device 108 is currently online (710). For example, the peripheral management device 102 may inspect the record for the peripheral device 108 in the database 116 to learn whether the peripheral device 108 is online or offline. If the peripheral device 108 is offline, then the peripheral management device 102 may queue the request until the peripheral device 108 comes back online (712), as may be specified by the request or which occur be default. In this case, the peripheral management device 102 proceeds from part 712 of the method 700 when the peripheral device 108 comes online. However, the request may instead specify that the management action be performed not be performed if the peripheral device 108 is not online when the request was sent or at the scheduled time, or this may be the default scenario. In this case, the method 700 may proceed to part 724, which is not denoted in FIG. 7.

Once the peripheral device 108 comes back online, or if the peripheral device 108 was already online, then the peripheral management device 102 transmits a corresponding request for performing the management action in question at the peripheral device 108, to the host device 104 to which the peripheral device 108 is connected (714). The peripheral management device 102 can identify the host device 104 to which the peripheral device 108 is connected by consulting the database 116 to learn the host device 104 currently associated with the peripheral device 108. The peripheral management device 102 does not have to determine whether the host device 104 is currently online, because if the peripheral device 108 is online, this means that its associated host device 104 is online. That is, a peripheral device 108 cannot be online if the host device 104 to which it is connected is not online.

The host device 104 receives the request from the peripheral management device 102 (716) and performs the requested action at the peripheral device 108 (718). The host device 104 can send a reply back to the peripheral management device 102 (720), which the peripheral management device 102 receives (722). For instance, the reply may indicate whether performance of the requested action was successfully completed or not (or whether it was performed or not), or may indicate the configuration settings that have changed as a result of the action being performed. The action may be a read-oriented action requesting information regarding the peripheral device 108, such as specified configuration settings, in which case the reply can include the requested configuration settings.

The peripheral management device 102 may in turn send a corresponding reply back to the client device 112 (724), which the client device 112 receives (726). For instance, the peripheral management device 102 may provide the information it received from the host device 104 in this reply. In the case in which the web server device 110 maintains a web site for the peripheral management device 102, the web server device 110 may update a dashboard indicating this information, which is correspondingly transmitted to the client device 112 as the reply. The peripheral management device 102 or the web server device 110 may maintain a log of performance of the management action, which the client device 112 later inspects as the reply, or a record of which the client device 112 receives as the reply. The reply may be in a different form as well, such as in a discrete message that the client device 112 receives.

FIG. 8 shows an example peripheral management device 800, which may implement the peripheral management device 102 that has been described. The peripheral management device 800 includes a network adapter 802, a processor 804, and a memory 806 storing program code 808. The network 802, which may for instance be a discrete network card or a network chipset, communicatively connects over a network with a client device and with host devices having peripheral devices. The program code 808 is executable by the processor 804 to provide centralized management of the peripheral devices of the host devices by the client device through the peripheral management device and the host devices.

FIG. 9 shows an example non-transitory computer-readable data storage medium 900. The computer-readable data storage medium stores program code 902 executable by a processor of a host device, such as the host device 104, to perform processing. The program code 902 can thus be the software agent 114 of the host device 104, or realize the software agent 114 upon execution. The processing includes receiving, from a peripheral management device over a network, a management action for a peripheral device of the host device initiated at a client device (904). The processing includes responsively performing the management action at the peripheral device to provide for centralized management of the peripheral device (906).

Techniques for centralized management of peripheral devices of host devices have been described. The peripheral devices may not have network connectivity or otherwise may not be communicatively connected to a network and as such may not be able to be directly centrally managed. The host devices thus act as proxies to permit the peripheral devices to be centrally managed.

We claim:

1. A peripheral management device comprising:
a network adapter to communicatively connect over a network with a client device and with a plurality of host devices having a plurality of peripheral devices;
a processor; and
a memory storing program code executable by the processor to provide centralized management of the peripheral devices of the host devices by the client device through the peripheral management device and the host devices.

2. The peripheral management device of claim 1, wherein the program code is executable by the processor to provide the centralized management of the peripheral devices without the client device establishing remote desktop control sessions with the host devices, without the client device directly communicating with the host devices over the network, and without the peripheral devices having to have network connectivity.

3. The peripheral management device of claim 1, wherein by executing the program code to provide the centralized management of the peripheral devices the processor performs processing comprising:
receiving a request from the client device to perform a management action at a selected peripheral device of a selected host device; and
transmitting a corresponding request to the selected host device to perform the management action at the selected peripheral device.

4. The peripheral management device of claim 3, wherein the request from the client device is received through a web server device to which the network adapter is communicatively connected over the network.

5. The peripheral management device of claim 3, wherein the processing further comprises:
responsively receiving a reply from the selected host device indicating completion of the management action at the selected peripheral device; and
transmitting a corresponding reply to the client device indicating the completion of the management action at the selected peripheral device.

6. The peripheral management device of claim 3, wherein the processing further comprises:
responsive to receiving the request, determining whether the selected peripheral device is online or offline;
in response to determining that the selected peripheral device is online, transmitting the corresponding request to the selected host device to perform the management action at the selected peripheral device; and
in response to determining that the selected peripheral device is offline, queuing the corresponding request and when both the selected host device and the selected peripheral device are online sending the corresponding request to the selected host device to perform the management action at the selected peripheral device.

7. The peripheral management device of claim 1, wherein by executing the program code to provide the centralized management of the peripheral devices the processor performs processing comprising:
receiving a request from the client device to perform a management action at a selected peripheral device of a selected host device at a scheduled time; and
at the scheduled time, transmitting a corresponding request to the selected host device to perform the management action at the selected peripheral device.

8. The peripheral management device of claim 1, wherein by executing the program code to provide the centralized management of the peripheral devices the processor performs processing comprising:
receiving a notification from a selected host device that a selected peripheral device of the selected host device has come online;
determining whether the selected peripheral device is recorded within a database;
in response to determining that the selected peripheral device is not recorded within the database, recording the selected peripheral device in the database;
determining whether the selected host device is associated with the selected peripheral device in the database;
in response to determining that the selected host device is not associated with the selected peripheral device in the database, associating the selected host device with the selected peripheral device in the database; and
indicating in the database that the selected peripheral device is online.

9. The peripheral management device of claim 1, wherein by executing the program code to provide the centralized management of the peripheral devices the processor performs processing comprising:
receiving a notification from a selected host device that the selected host device has come online, the notification including a selected peripheral device of the selected host device that is also online;
determining whether the selected host device is recorded within a database;
in response to determining that the selected host device is not recorded within the database, recording the selected host device in the database;
determining whether the selected peripheral device is recorded within the database;
in response to determining that the selected peripheral device is not recorded within the database, recording the selected peripheral device to the database;
determining whether the selected host device is associated with the selected peripheral device in the database;
in response to determining that the selected host device is not associated with the selected peripheral device in the database, associating the selected host device with the selected peripheral device in the database; and
indicating in the database that the selected host device and the selected peripheral device are online.

10. The peripheral management device of claim 1, wherein the peripheral devices are organized over a plurality of groups of a plurality of different group types, and the centralized management of the peripheral devices is provided at a group level of one group or of multiple groups,
and wherein the different group types are each selected from a plurality of group types comprising a user associated with each host device, a location of each host device, and a type of each peripheral device of each host device.

11. The peripheral management device of claim 1, wherein the peripheral devices comprise display devices, and the central management comprises display device firmware management and display device configuration settings management.

12. A non-transitory computer-readable data storage medium storing program code executable by a host device having a peripheral device to perform processing comprising:
receiving, from a peripheral management device over a network, a management action for the peripheral device initiated at a client device; and
responsively performing the management action at the peripheral device to provide for centralized management of the peripheral device.

13. The non-transitory computer-readable data storage medium of claim 12, wherein the management action is performed at the peripheral device without the client device establishing a remote desktop session with the host device, without the client device directly communicating with the host device over the network, and without the peripheral device having to have network connectivity.

14. The non-transitory computer-readable data storage medium of claim 12, wherein the processing further comprises:
responsive to the peripheral device coming online, transmitting a notification to the peripheral management device indicating that the peripheral device is online; and
responsive to the peripheral device going offline, transmitting a notification to the peripheral management device indicating that the peripheral device is offline.

15. The non-transitory computer-readable data storage medium of claim 12, wherein the processing further comprises:
upon the host device coming online, determining that the peripheral device is online; and
transmitting a notification to the peripheral management device indicating that the host device is online and that the peripheral device is online.
